(19) United States
(12) Patent Application Publication
(10) Pub. No.: US 2016/0052744 A1
(43) Pub. Date: Feb. 25, 2016

(54) SHEET DISCHARGE MECHANISM

(71) Applicants: KABUSHIKI KAISHA TOSHIBA, Tokyo (JP); TOSHIBA TEC KABUSHIKI KAISHA, Tokyo (JP)

(72) Inventor: KIKUO MIZUTANI, Izu Shizuoka (JP)

(21) Appl. No.: 14/465,684

(22) Filed: Aug. 21, 2014

(51) Int. Cl. B65H 31/34; G06K 15/16; B65H 31/08

(52) U.S. Cl. CPC B65H 31/34; B65H 31/08; G06K 15/16

(57) ABSTRACT

A sheet discharge mechanism according to an embodiment includes a tray with a loading surface on which discharged sheets are loaded. An alignment plate extends from a downstream side of the loading surface in a sheet discharge direction. An alignment roller contacts an uppermost sheet loaded on the loading surface at a predetermined position, and rotates while contacting the uppermost sheet to align the sheets against the alignment plate. A support mechanism elastically supports the tray so that at least a portion of the tray around the predetermined position moves downward in accordance with an increase in weight of sheets loaded on the loading surface. A height adjustment mechanism maintains a minimum height of sheets when the portion of the tray around the predetermined position moves downward by a predetermined distance or more in accordance with the increase in weight of sheets loaded on the loading surface.

### FIELD

Embodiments described herein relate generally to a tray which carries discharged sheets.

### BACKGROUND

A sheet supply tray of the related art has a raised part of a loading surface on which sheets are loaded. The raised part corresponds to an area pressed by an alignment roller. The raised part of the loading surface enables alignment of the sheets by the alignment roller regardless of the loaded condition of the sheets. However, when this technique is applied to a discharge tray, it is possible that a contact produced between the tip of a discharged sheet and the raised part of the loading surface may cause a jamming of the sheet.

### DESCRIPTION OF THE DRAWINGS

FIG. 1 is a schematic illustration of a decolorizing apparatus.

FIG. 2 is a block diagram showing hardware structure of the decolorizing apparatus.

FIG. 3 is a perspective view of a sheet discharge mechanism, according to a first embodiment.

FIG. 4 is a perspective view of an alignment roller, according to an aspect of the first embodiment.

FIG. 5 is a cross-sectional view of the sheet discharge mechanism according to the first embodiment, taken along a line A-A′.

FIG. 6 is a cross-sectional view of the sheet discharge mechanism according to the first embodiment, in a condition where a height adjustment member adjusts the height of sheets.

FIG. 7 illustrates a sheet discharge mechanism that is not equipped with a height adjustment mechanism.

FIG. 8 illustrates the sheet discharge mechanism in the condition where the height of the sheets is adjusted according to the first embodiment.

FIG. 9 is a cross-sectional view of a related-art sheet discharge mechanism in a condition where a jam has been caused.

FIG. 10 is a cross-sectional view of a sheet discharge mechanism according to a second embodiment, in a condition where a height adjustment member adjusts the height of sheets.

FIG. 11 illustrates a sheet discharge mechanism according to a third embodiment, in a condition where a height adjustment member adjusts the height of sheets.

FIG. 12 illustrates a loading surface and the height adjustment member of the sheet discharge mechanism according to the third embodiment.

### DETAILED DESCRIPTION

A sheet discharge mechanism according to an embodiment includes a tray with a loading surface on which discharged sheets are loaded. An alignment plate extends from a downstream side of the loading surface in a sheet discharge direction. An alignment roller contacts an uppermost sheet loaded on the loading surface at a predetermined position, and rotates while contacting the uppermost sheet to align the sheets against the alignment plate. A support mechanism elastically supports the tray so that at least a portion of the tray around the predetermined position moves downward in accordance with an increase in weight of sheets loaded on the loading surface. A height adjustment mechanism maintains a minimum height of sheets loaded on the loading surface in the predetermined position such that the alignment roller contacts the uppermost sheet loaded on the loading surface when the portion of the tray around the predetermined position moves downward by a predetermined distance or more in accordance with the increase in weight of sheets loaded on the loading surface.

Exemplary embodiments are hereinafter described with reference to the drawings.

### First Embodiment

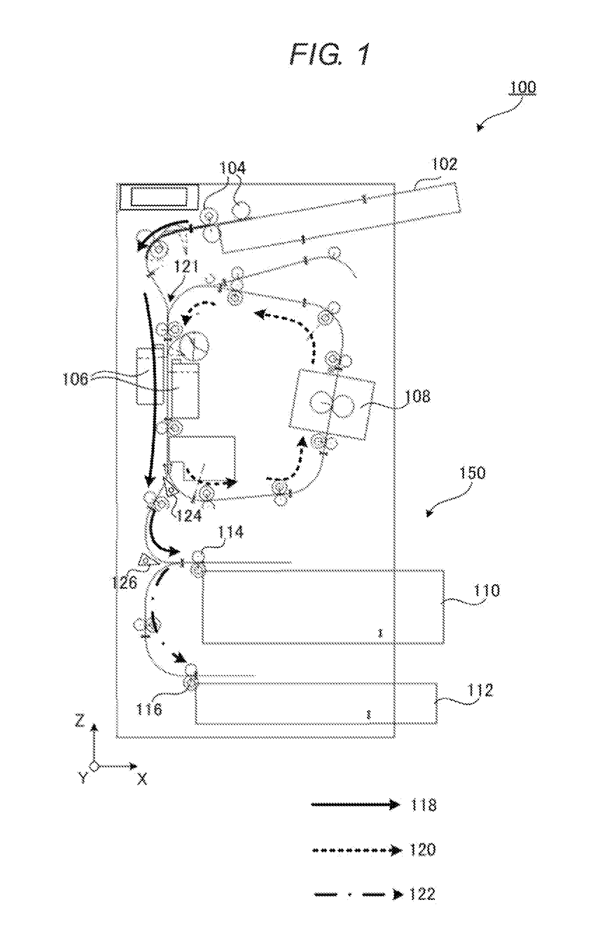

FIG. 1 is a schematic illustration of a decolorizing apparatus 100.

The decolorizing apparatus 100 includes a sheet supply tray 102, a sheet supply roller 104, a scanner unit 106, a decolorizing unit 108, a discharge unit 150, a first transfer path 118, a second transfer path 120, a third transfer path 122, and a first separator 124. The discharge unit 150 contains a first discharge tray 110, a second discharge tray 112, a first discharge roller 114, a second discharge roller 116, and a second separator 126.

A sheet loaded on the sheet supply tray 102 is a sheet on which a decolorable toner image is formed. The sheet transferred to the first transfer path 118 (by the function of the sheet supply roller 104) passes through the scanner unit 106. The decolorable toner in this context is toner capable of being decolorized when heated to a predetermined temperature.

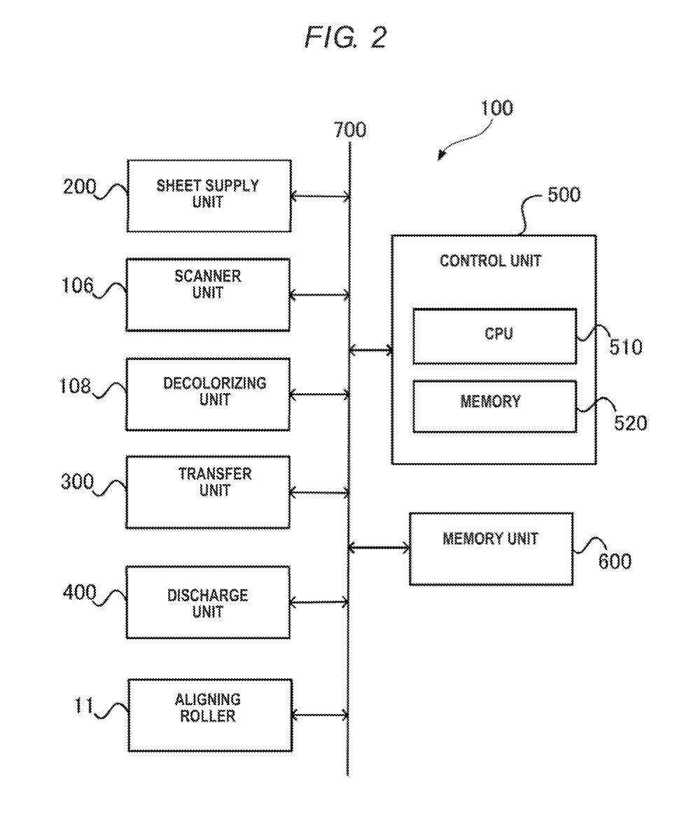

The scanner unit 106 includes two scanners opposed to each other, with the first transfer path 118 interposed between the two scanners. The scanner unit 106 reads the images formed on both surfaces of the sheet passing through the scanner unit 106. Image data read by the scanner unit 106 is stored in a memory unit 600 (see FIG. 2).

The sheet that has passed through the scanner unit 106 is guided by the first separator 124 toward the second transfer path 120 or the first discharge tray 110. When an image is formed on the sheet (as determined from the image data read by the scanner unit 106), the first separator 124 transfers the sheet toward the second transfer path 120. When no image is formed on the sheet, the first separator 124 guides the sheet toward the first discharge tray 110.

The sheet transferred to the second transfer path 120 is heated by the decolorizing unit 108 for decolorizing treatment, and then joins the first transfer path 118 at a junction 121. The sheet having joined the first transfer path 118 is again scanned by the scanner unit 106.

When the image formed on the sheet has been decolorized at the time of the sheet passing through the scanner unit 106 again, the second separator 126 guides the sheet toward the first discharge tray 110. When the image formed on the sheet has not been fully decolorized, the second separator 126 guides the sheet toward the third transfer path 122, and the sheet is conveyed thereon for transfer to the second discharge tray 112.

FIG. 2 is a block diagram showing hardware structure of the decolorizing apparatus 100.

The decolorizing apparatus 100 includes a sheet supply unit 200, the scanner unit 106, the decolorizing unit 108, a transfer unit 300, a discharge unit 400, an alignment roller 11, a control unit 500, and the memory unit 600, all of which are connected with each other via a communication bus 700.

The sheet supply unit 200 contains the sheet supply tray 102 and the sheet supply roller 104, and supplies sheets loaded on the sheet supply tray 102 to the first transfer path 118. The transfer unit 300 contains the first separator 124, the second separator 126, and a transfer roller (not shown), and transfers sheets supplied within the first through third transfer paths. The discharge unit 400 contains the first discharge tray 110, the second discharge tray 112, the first discharge roller 114, and the second discharge roller 116, and discharges sheets obtained after the decolorizing treatment to the discharge tray (first discharge tray 110 or second discharge tray 112).

The control unit 500 contains a CPU 510 and a memory 520. The CPU 510 executes a computer program stored in the memory 520 to control the operation of the decolorizing apparatus 100. The memory 520 may be ROM (read only memory), RAM (random access memory), EEPROM (electrically erasable programmable read-only memory), or the like. The memory 520 stores the computer program used for controlling the decolorizing apparatus 100, and various types of data created at the time of execution of the computer program. The computer program stored in the memory 520 is further read by the control unit 500, whereupon execution of the computer program starts. The memory unit 600 stores image data and the like scanned by the scanner unit 106.

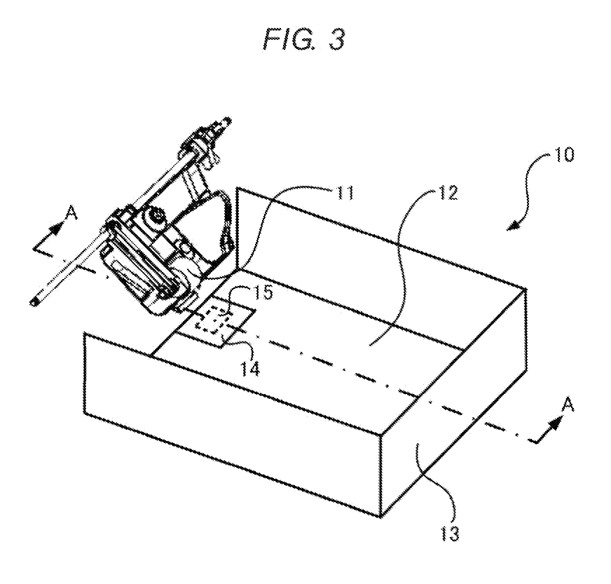

FIG. 3 is a perspective view illustrating a sheet discharge mechanism 10 according to the first embodiment. In the following description of this embodiment, an aligning method of sheets discharged to the first discharge tray 110 (see FIG. 1) is also discussed. It should be understood that the sheet discharge mechanism 10 is employed not only for the first discharge tray 110, but also may be adopted for the second discharge tray 112. The sheet discharge mechanism 10 includes the alignment roller 11, a loading surface 12, an alignment plate 13, and a height adjustment member 14. The alignment roller 11 rotates while pressing an uppermost sheet P of sheets P (not shown) discharged onto the loading surface 12 to bring the sheets P into abutment with the alignment plate 13 and achieve alignment of the sheets P. The alignment plate 13 extends from the downstream side end of the loading surface 12 in the sheet discharge direction. The height adjustment member 14 is positioned on the loading surface 12, embedded therein in the vicinity of the upstream side end of the loading surface 12 in the sheet discharge direction. The height adjustment member 14 will be detailed later.

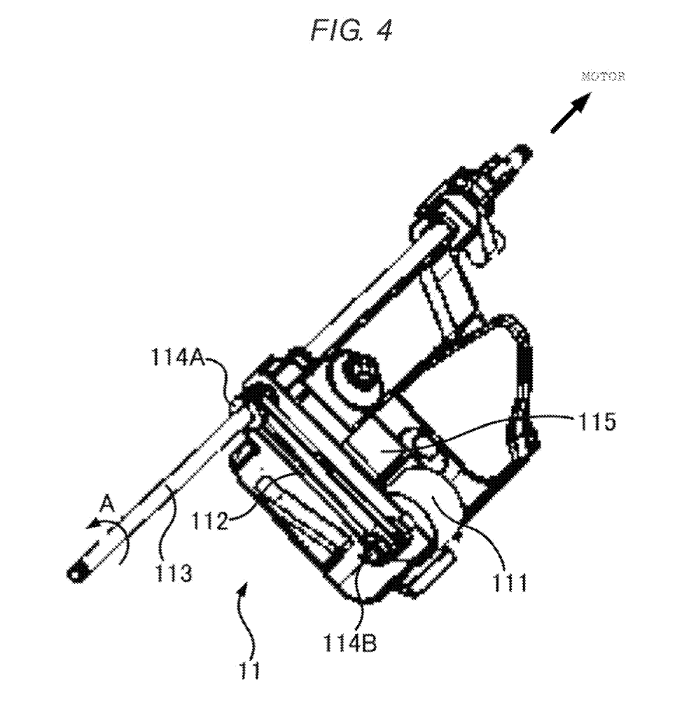

FIG. 4 is a perspective view of the alignment roller 11.

Initially, a shaft 113 rotates in the direction indicated by an arrow A in accordance with the driving of a motor (not shown). When the shaft 113 rotates, a pulley 114A fixed to the shaft 113 rotates in the direction of the arrow A accordingly. A belt, which is attached to both the pulley 114A and a pulley 114B, provides a mechanism for rotating the pulley 114B in accordance with the rotation of the pulley 114A. The pulley 114B is coupled to a roller 111 via a shaft (not-shown), so that the torque from the pulley 114B is transmitted to the roller 111. This structure allows transmission of torque from the motor to the roller 111. A roller support portion 115 is rotatably attached to the shaft 113 and is rotatable in accordance with the movement of the shaft 113.

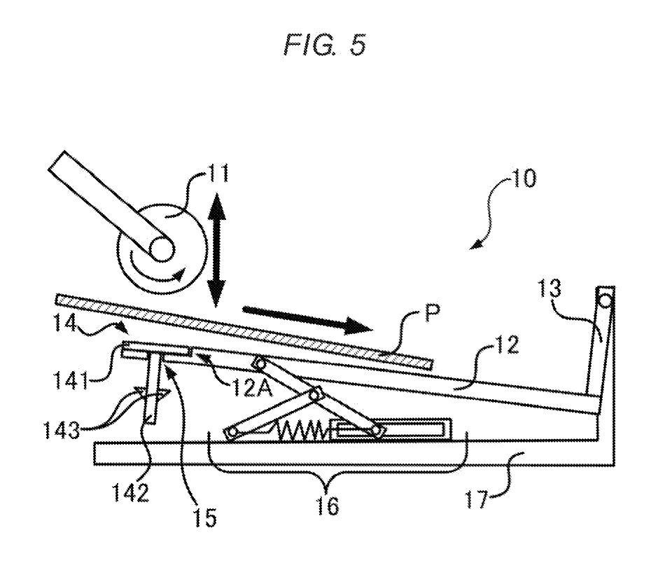

FIG. 5 is a cross-sectional view of the sheet discharge mechanism according to the first embodiment, taken along a line A-A′. FIG. 3 does not show a support mechanism 16 and a bottom plate 17 illustrated in FIG. 5. A method for aligning the discharged sheets P is also discussed in conjunction with FIG. 5.

The sheet P, after being subject to decolorizing treatment, is discharged onto the loading surface 12. The alignment roller 11 rotates while pressing the sheet P to transfer the sheet P in the sheet discharge direction and bring the sheet P into abutment with the alignment plate 13. This abutment of the sheet P with the alignment plate 13 achieves alignment of the sheet P.

The upper end of the alignment plate 13 is rotatably supported by the bottom plate 17. The support mechanism 16 supports the loading surface 12 so that the loading surface 12 moves downward in accordance with increase in the weight of the sheets P to be loaded. When loading the sheets P, the loading surface 12 moves downward by the weight of the sheets P. As discussed above, the alignment plate 13 extending from the loading surface 12 is rotatably supported by the bottom plate 17. Thus, the inclined position of the loading surface 12 comes close to the horizontal position as the loading surface 12 moves downward. In other words, the loading surface 12 is supported by the support mechanism 16 in such a manner as to be movable upward and downward.

The height adjustment member 14 is disposed at a position on the loading surface 12 in the vicinity of the upstream side end thereof in the sheet discharge direction, and at the center in the direction perpendicular to the sheet discharge direction. The height adjustment member 14 has a push-up plate 141, a push-up stay 142, and a regulating piece 143. The loading surface 12 has a recess 12A at the upstream side end in the sheet discharge direction and at the center in the direction perpendicular to the sheet discharge direction. The push-up plate 141 is positioned within the recess 12A. When the sheet P is not loaded on the loading surface 12, the push-up plate 141 is supported in such a condition that the upper surface of the push-up plate 141 is flush with the upper surface (loading surface) of the loading surface 12. This structure prevents contact between the sheet P and the push-up plate 141 if the sheet P is discharged while bent downward, and avoids resultant jamming of the sheet P. The push-up stay 142 is fixed to the bottom surface of the push-up plate 141. According to this embodiment, the push-up stay 142 is fixed to the center of the bottom surface of the push-up plate 141. The regulating piece 143 is a projection positioned on the side surface of the push-up stay 142, and prevents separation of the push-up stay 142 in the upward direction to avoid separation of the height adjustment member 14 from the loading surface 12. If the regulating piece 143 is not present on the height adjustment member 14, the height adjustment member 14 could possibly be inadvertently separated from the loading surface 12. The height adjustment member 14 is not fixed to the loading surface 12. The push-up plate 141 of the height adjustment member 14 is placed on the recess 12A of the loading surface 12 to be supported thereon. This arrangement allows separate movements of the loading surface 12 and the height adjustment member 14 independently from each other.

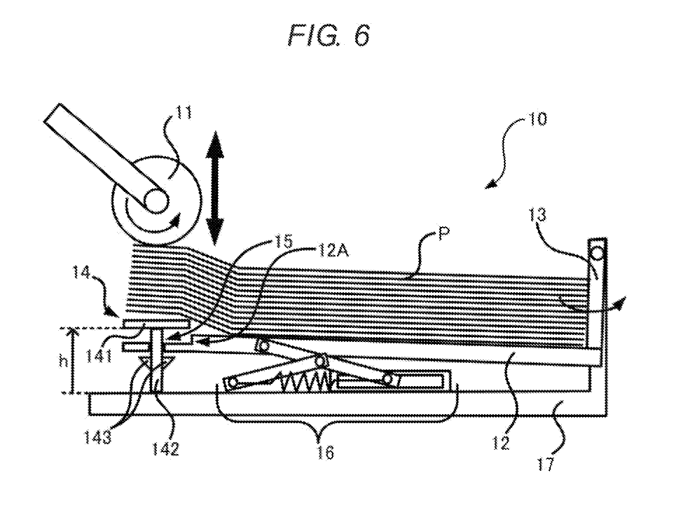

FIG. 6 illustrates the sheet discharge mechanism according to the first embodiment, in a condition where the loaded sheets are pushed up by the height adjustment member.

As the number of the sheets P loaded on the loading surface 12 increases, the loading surface 12 and the height adjustment member 14 move downward in accordance with the weight of the sheets P. When the upstream side end of the loading surface 12 in the sheet transfer direction moves downward and reaches a predetermined height (lower limit height h), the lower end of the push-up stay 142 of the height adjustment member 14 contacts the bottom plate 17. This contact between the push-up stay 142 and the bottom plate 17 stops further downward movement of the push-up plate 141. Accordingly, the contact does not allow downward movement of the push-up plate 141 to a position lower than the lower limit height h. The height adjustment member 14 is supported only by the engagement between the recess 12A and the push-up plate 141 placed on the recess 12A. In this case, the downward movement of the push-up plate 141 is stopped at the height equal to the lower limit height h, whereas the loading surface 12 is allowed to move downward further to a position lower than the lower limit height h. In other words, when the loading surface 12 is located at a position lower than the lower limit height h, the push-up plate 141 is located at a position higher than the loading surface 12. Accordingly, as the number of the sheets P loaded on the loading surface 12 increases, the height adjustment member 14 pushes up the sheets P relatively to the loading surface 12.

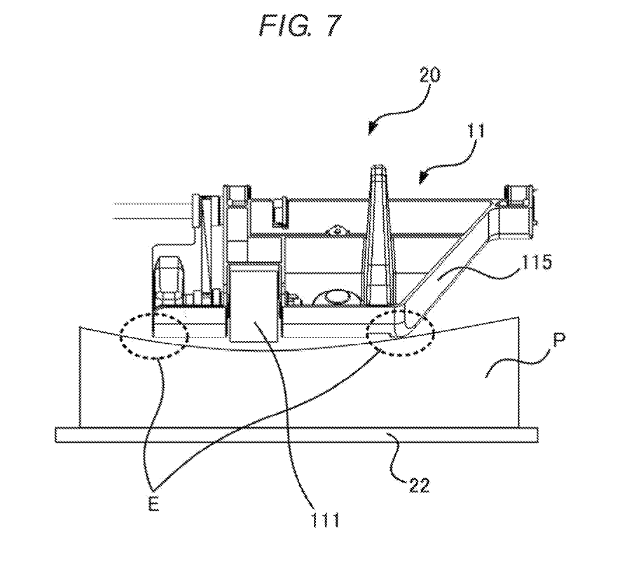

FIG. 7 illustrates a view from the upstream side in the sheet discharge direction of a related-art sheet discharge mechanism which does not contain the height adjustment member 14 described above.

The alignment roller 11 rotates while pressing the sheets P so as to align the sheets P. When the height adjustment member 14 is not provided on the sheet discharge mechanism, a pressure is applied to a pressing position of the sheets P by the alignment roller 11. In this case, a dent is produced at the pressing position of the sheets P and becomes larger as the number of the loaded sheets P increases. Specifically, the sheets P may be curled due to the decolorization process, resulting in a dent in the stack of sheets P, as seen in FIG. 7. The dent enlarging at the pressing position of the sheets P finally results in contact at positions E between the sheets P and the roller support portion 115 supporting the roller 111 of the alignment roller 11. In this condition, the roller 111 idles with no contact produced between the roller surface and the sheet upper surface.

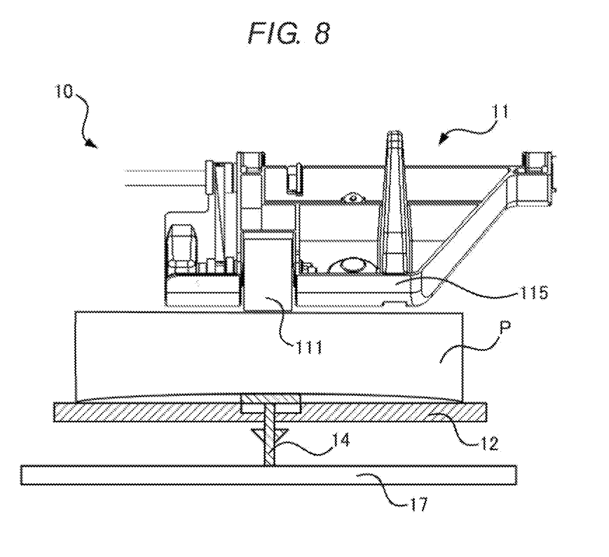

FIG. 8 illustrates the sheet discharge mechanism according to the first embodiment as viewed from the upstream side in the sheet discharge direction.

In this embodiment, the height adjustment member 14 pushes up a group of the sheets P as illustrated in FIG. 8 to prevent formation of a dent at the pressing position of the sheets P and thereby avoid the contact between the roller support portion 115 and the sheets P. More specifically, the height adjustment member 14 maintains the sheets P in such a condition that the sheet P loaded at the uppermost position of the group of the sheets P are supported relatively flat. In other words, the height adjustment member 14 supports the sheets P in such a position that the alignment roller 11 may contact the sheet P loaded at the uppermost position of the group of the sheets P.

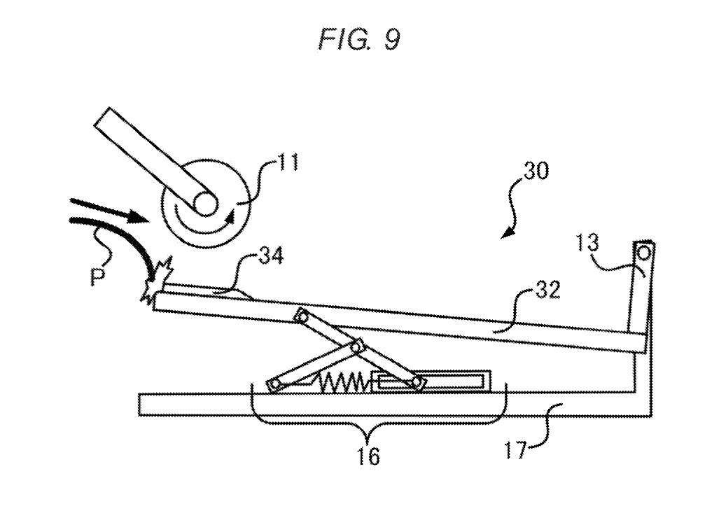

FIG. 9 is a schematic illustration of the related-art sheet discharge mechanism in which a jam has occurred.

According to the related-art mechanism, a part of a loading surface 32 of a sheet supply mechanism 30 (i.e., the position pressed by a sheet supply roller 31) is raised beforehand to prevent formation of a dent in the group of the sheets P at the pressing position. The part of the loading surface 32 is raised before discharge of the sheet by a sheet discharge mechanism (not shown). However, there is a possibility that the sheet P contacts the raised part and causes jamming when the sheet P is discharged while bent downward. On the other hand, according to the first embodiment described above, an arrangement is made such that no step is produced between the upper surface of the height adjustment member 14 and the upper surface (loading surface) of the loading surface 12 when the sheets P are not loaded on the loading surface 12 as illustrated in FIG. 5. This structure may reduce the possibility of jamming of the sheet P.

### Second Embodiment

The height adjustment mechanism and the loading surface included in a sheet discharge mechanism 10 according to a second embodiment are different from the corresponding structures in the first embodiment.

Components and parts having similar functionalities shown in the description of the second embodiment are given reference numbers similar to those of the corresponding components and parts in the first embodiment, and the same explanation thereabout is not repeated herein.

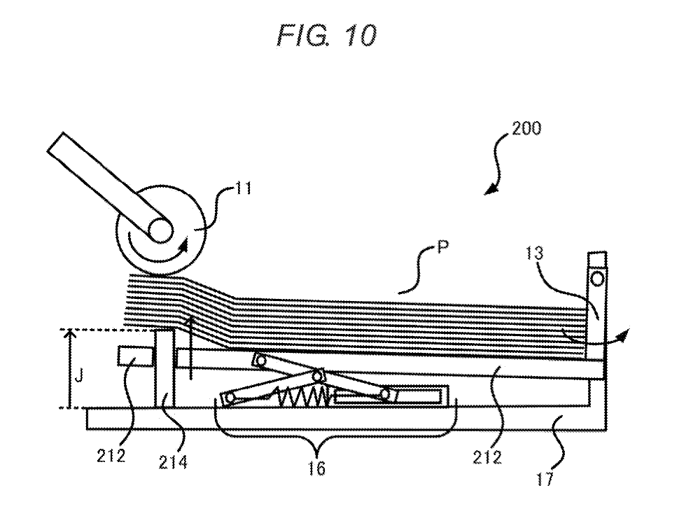

FIG. 10 is a cross-sectional view illustrating the sheet discharge mechanism 10 according to a second embodiment. The sheet discharge mechanism 10 in the second embodiment includes the alignment roller 11, the alignment plate 13, the support mechanism 16, the bottom plate 17, a loading surface 212, and a height adjustment member 214.

Similarly to the first embodiment, a part of the sheets P loaded on the loading surface 212 is pushed up to prevent jamming of the sheets P in the second embodiment.

As the number of the sheets P loaded on the loading surface 212 increases, the loading surface 212 moves downward in accordance with the weight of the sheets P. The loading surface 212 is supported by the support mechanism 16. According to the second embodiment, the height adjustment member 214 is stay-shaped, and rises from the bottom plate 17. When the loading surface 212 reaches such a position that the upstream side end of the loading surface 212 in the sheet discharge direction is lower than a lower limit height 3, the height adjustment member 214 projects from a hole 215 relatively to the loading surface 212. This projection of the height adjustment member 214 is generated because the height adjustment member 214 is fixed to the bottom plate 17, while the loading surface 212 moves downwardly. According to the second embodiment, the lower limit height J corresponds to the height of the height adjustment member 214. When the sheets P are not loaded on the loading surface 212, the upstream side end of the loading surface 212 in the sheet discharge direction is located above the lower limit height J. This condition resolves the problem that the discharged sheet P contacts the projected portion of the height adjustment member 214 and causes jamming of the sheet P. In other words, a jam may occur when the height adjustment member 214 projects from the hole 215 with none of the sheets P loaded on the loading surface 212, a condition avoided in the second embodiment. The hole 215 is positioned in the vicinity of the upstream side end of the loading surface 212 in the sheet discharge direction and at the center of the loading surface 212 in the direction perpendicular to the sheet discharge direction. The height adjustment member 214 is fixed to such a position that projection of the height adjustment member 214 from the hole 215 is allowed.

### Third Embodiment

The height adjustment member and the loading surface included in a sheet discharge mechanism 10 according to a third embodiment are different from the corresponding structures in the first embodiment.

Components and parts having similar functionalities shown in the description of the third embodiment are given reference numbers similar to those of the corresponding components and parts in the first embodiment, and the same explanation thereabout is not repeated herein.

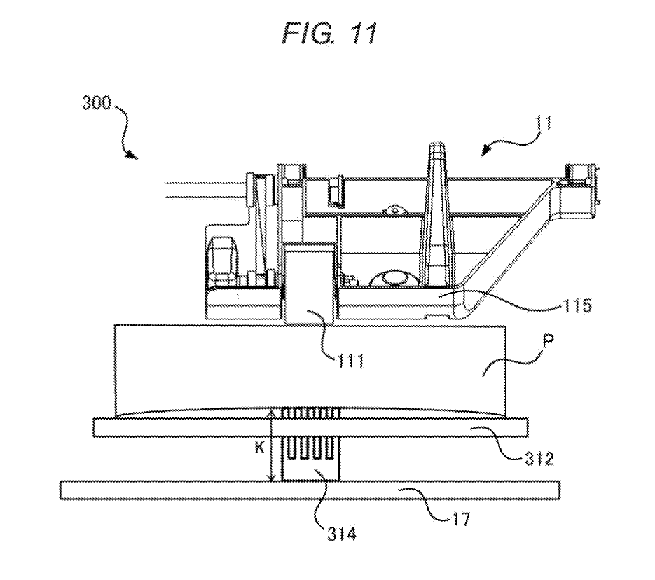

FIG. 11 is a front view of a sheet discharge mechanism according to the third embodiment. FIG. 11 shows a sheet discharge mechanism 10 as viewed from the upstream side in the sheet discharge direction. The sheet discharge mechanism 10 in the third embodiment includes the alignment roller 11, the alignment plate 13 (not shown), the support mechanism 16 (not shown), the bottom plate 17, a loading surface 312, and a height adjustment member 314.

Similar to the above embodiments, the height adjustment member 314 of the sheet discharge mechanism 300 pushes up the sheets P loaded on the loading surface 312 to prevent jamming of the sheets P.

When the sheets P are discharged to the loading surface 312, the loading surface 312 moves downward in accordance with the weight of the sheets P. The loading surface 312 is supported by the support mechanism 16. The height adjustment member 314 is fixed to the bottom plate 17 in the sheet discharge mechanism 300. When the upstream side end of the loading surface 312 in the sheet discharge direction moves downward and reaches a position lower than a lower limit height K, the height adjustment member 314 projects from the loading surface 312 and pushes up the sheets P. The height of the height adjustment member 314 corresponds to the lower limit height K.

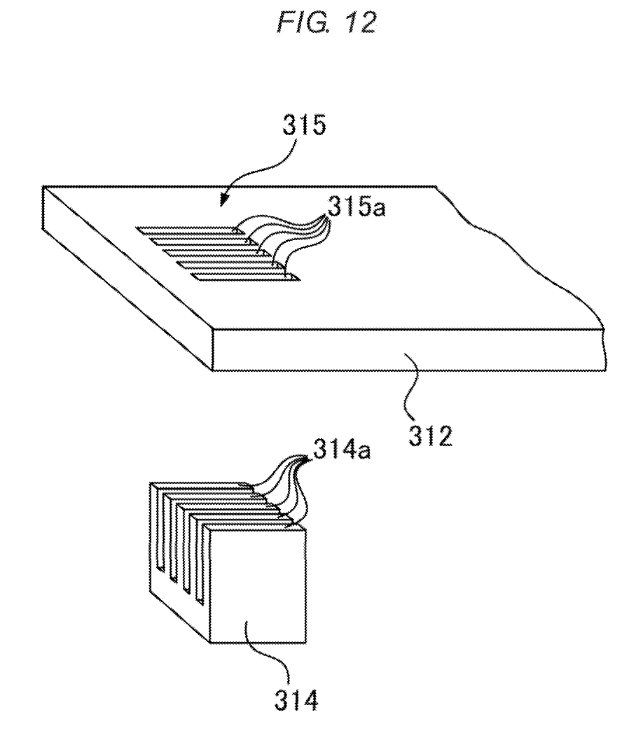

FIG. 12 illustrates the loading surface and the height adjustment member according to the third embodiment.

The height adjustment member 314 is comb-shaped, and fixed to the bottom plate 17 in such a condition that teeth 314a corresponding to teeth of a comb are directed upward. In the third embodiment, the height adjustment member 314 has five teeth 314a.

The loading surface 312 has holes 315. According to this embodiment, each of five holes 315a are so sized as to allow insertion of the corresponding teeth 314a through the hole.

More specifically, when the upstream side end of the loading surface 312 in the sheet discharge direction reaches a position lower than the lower limit height K in FIG. 11, the teeth 314a of the height adjustment member 314 pass through the corresponding holes 315a, whereby the teeth 314a having passed through the holes 315a push up the sheets P.

In the respective embodiments, the apparatus to which sheets are discharged need not be a decolorizing apparatus. For example, the apparatus to which sheets are discharged may be an image forming apparatus.

In the respective embodiments, the mechanism on which the loading surface is supported need not be the mechanism shown in FIG. 5 or other figures. The mechanism supporting the loading surface may be of other types as long as the loading surface is so supported as to move downward in accordance with the weight of sheets.

The height adjustment member adjusting the height of sheets for alignment need not be those discussed in the respective embodiments. The height adjustment member may be of other types as long as the sheets P are maintained at the lower limit height or higher so that stable alignment of the sheets is allowed when the loading surface reaches a position lower than the lower limit height.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A sheet discharge mechanism, comprising:
a tray including a loading surface on which discharged sheets are loaded;
an alignment plate extending from a downstream side of the loading surface in a sheet discharge direction;
an alignment roller configured to contact an uppermost sheet loaded on the loading surface at a predetermined position, and to rotate while contacting the uppermost sheet to align the sheets against the alignment plate;
a support mechanism elastically supporting the tray so that at least a portion of the tray around the predetermined position moves downward in accordance with an increase in weight of sheets loaded on the loading surface;
a height adjustment mechanism configured to maintain a minimum height of sheets loaded on the loading surface in the predetermined position such that the alignment roller contacts the uppermost sheet loaded on the loading surface when the portion of the tray around the predetermined position moves downward by at least a predetermined distance in accordance with the increase in weight of sheets loaded on the loading surface; and
a bottom plate supporting the tray, the tray being movable upward and downward relative to the bottom plate, wherein
the height adjustment mechanism includes a push-up stay having an upper end disposed in portion of the loading surface and a lower end configured to contact a top of the bottom plate, and
the upper end of the push-up stay supports sheets loaded on the loading surface at the minimum height when the portion of the tray around the predetermined position moves downward by the predetermined distance or more.

2. The sheet discharge mechanism according to claim 1, wherein the height adjustment mechanism includes a top surface that is flush with the loading surface when no sheet is loaded on the loading surface.

3. The sheet discharge mechanism according to claim 1,
wherein
the upper end of the push-up stay is disposed in a recess portion of the loading surface.

4. The sheet discharge mechanism according to claim 1, wherein the push-up stay includes a regulating piece configured to prevent removal of the push-up stay in an upward direction.

5.-6. (canceled)

7. The sheet discharge mechanism according to claim 1, wherein no portion of the height adjustment mechanism extends above the tray when the portion of the tray around the predetermined position has not moved downward by the predetermined distance or more.

8. A decolorizing unit, comprising:
a decolorizing unit configured to decolorize toner images formed on the sheets with decolorable toner;
a tray including a loading surface on which sheets that have been subject to decolorization by the decoloring unit are loaded;
an alignment plate extending from a downstream side of the loading surface in a sheet discharge direction;
an alignment roller configured to contact an uppermost sheet loaded on the loading surface at a predetermined position, and to rotate while contacting the uppermost sheet to align the sheets against the alignment plate;
a support mechanism elastically supporting the tray so that at least a portion of the tray around the predetermined position moves downward in accordance with an increase in weight of sheets loaded on the loading surface;
a height adjustment mechanism configured to maintain a minimum height of sheets loaded on the loading surface in the predetermined position such that the alignment roller contacts the uppermost sheet loaded on the loading surface when the portion of the tray around the predetermined position moves downward by at least a predetermined distance in accordance with the increase in weight of sheets loaded on the loading surface; and
a bottom plate supporting the tray, the tray being movable upward and downward relative to the bottom plate, wherein
the height adjustment mechanism includes a push-up stay having a lower end mounted to a top of the bottom plate and an upper end configured to move through a hole in the tray when the portion of the tray around the predetermined position moves downward by a predetermined distance or more in accordance with the increase in weight of sheets loaded on the loading surface.

9. The decolorizing unit according to claim 8, wherein the height adjustment mechanism includes a top surface that is flush with the loading surface when no sheet is loaded on the loading surface.

10.-12. (canceled)

13. The decolorizing unit according to claim 8, wherein the upper end of the push up stay includes plural teeth configured to move through plural holes in the tray, respectively.

14. The decolorizing unit according to claim 8, wherein no portion of the height adjustment mechanism extends above the tray when the portion of the tray around the predetermined position has not moved downward by the predetermined distance or more.

15. A sheet loading method comprising the steps of:
loading sheets on a loading surface of a tray;
rotating an alignment roller in contact with an uppermost sheet loaded on the loading surface at a predetermined position to align the sheets against an alignment plate extending from an end of the tray in a sheet loading direction;
elastically supporting the tray so that at least a portion of the tray around the predetermined position moves downward in accordance with an increase in weight of sheets loaded on the loading surface; and
maintaining a minimum height of sheets loaded on the loading surface in the predetermined position such that the alignment roller contacts the uppermost sheet loaded on the loading surface when the portion of the tray around the predetermined position moves downward by at least a predetermined distance in accordance with the increase in weight of sheets loaded on the loading surface, wherein
the tray is elastically movable upward and downward relative to a bottom plate, and
a push-up stay maintains the minimum height of the sheets loaded on the loading surface in the predetermined position,
the push-up stay including an upper end disposed in a recess portion of the loading surface and a lower end configured to contact a too of the bottom plate, and the upper end of the push-up stay supporting sheets loaded on the loading surface at the minimum height when the portion of the tray around the predetermined position moves downward by the predetermined distance or more.

16. The sheet loading method according to claim 15, wherein a top surface of a height adjusting mechanism that supports the sheets at the predetermined position is flush with the loading surface when no sheet is loaded on the loading surface.

17. (canceled)

18. The sheet loading method according to claim 15, wherein the push-up stay includes a regulating piece configured to prevent removal of the push-up stay in an upward direction.

19. The sheet loading method according to claim 15, wherein the upper end of the push up stay includes plural teeth configured to move through plural holes in the tray, respectively.

20. The sheet loading method according to claim 16, wherein no portion of the height adjustment mechanism extends above the tray when the portion of the tray around the predetermined position has not moved downward by the predetermined distance or more.
